(19) United States
(12) Patent Application Publication
(10) Pub. No.: US 2025/0239423 A1
(43) Pub. Date: Jul. 24, 2025

(54) INDUCTIVE KEYBOARD DEVICE

(71) Applicant: Chicony Electronics Co., Ltd., New Taipei City (TW)

(72) Inventors: Shih-Hao Lu, New Taipei City (TW); Cheng-Chi Hsu, New Taipei City (TW)

(21) Appl. No.: 18/975,294

(22) Filed: Dec. 10, 2024

(30) Foreign Application Priority Data
Jan. 24, 2024 (TW) 113102825

(51) Int. Cl. H01H 13/70

(52) U.S. Cl. CPC H01H 13/70

(57) ABSTRACT

An inductive keyboard device includes a circuit board, an annular inductor, and a key. The circuit board has an assembling region, and the assembling region has a hole. The annular inductor is in the hole, and the annular inductor is arranged to form an axial sensing channel. The key includes a keycap and a magnetic component. The keycap is above the assembling region and at a height position, the magnetic component is connected to the keycap, and a position of the magnetic component corresponds to a position of the axial sensing channel. The keycap can have a movement from the height position toward the circuit board. During the movement of the keycap, the keycap drives the magnetic component to be moved axially in the axial sensing channel of the annular inductor.

### CROSS-REFERENCE TO RELATED APPLICATION

This non-provisional application claims priority under 35 U.S.C. § 119 (a) to Patent Application No. 113102825 filed in Taiwan, R.O.C. on Jan. 24, 2024, the entire contents of which are hereby incorporated by reference.

### BACKGROUND

### Technical Field

The instant disclosure relates to a keyboard device, in particular, to an inductive keyboard device.

### Related Art

Keyboards are common input devices. Usually, the keyboards are used along with daily computer products (such as notebook computers, laptops, or tablets), industrial scaled control equipment, or processing equipment for operation or text inputs.

### SUMMARY

In general, for a keyboard known to the inventor, the key can only be switched between two states. Take the membrane keyboard as an example, a membrane keyboard known to the inventor includes several keys and a membrane circuit board. When the key is pressed, the circuit on the membrane circuit board is conducted to determine that the key is pressed; when the key is released, the circuit on the membrane circuit board is not conducted to determine that the key is not pressed.

In one embodiment, an inductive keyboard device is provided and comprises a circuit board, an annular inductor, and a key. The circuit board has an assembling region, and the assembling region has a hole. The annular inductor is in the hole, and the annular inductor is arranged to form an axial sensing channel. The key comprises a keycap and a magnetic component. The keycap is above the assembling region and at a height position, the magnetic component is connected to the keycap, and a position of the magnetic component corresponds to a position of the axial sensing channel. The keycap selectively has a movement from the height position toward the circuit board. Moreover, during the movement of the keycap, the keycap drives the magnetic component to be moved axially in the axial sensing channel of the annular inductor.

Based on above, in the inductive keyboard device according to one or some embodiments of the instant disclosure, when the keycap is pressed to be moved from the height position toward the circuit board, the keycap can drive the magnetic component to be moved axially in the axial sensing channel of the annular inductor. Therefore, the annular inductor can generate different inductance values continuously during the movement of the keycap, and the position of the keycap can be thus determined according to the change of the inductance values. Hence, the inductive keyboard device can provide the user with various operation modes to meet different user requirements and application scenarios. Moreover, because the inductance value is related to the movement of the keycap, the change of the inductance values can be achieved more linearly, and the inductive keyboard device can provide the user with more detail and accurate control operations.

### BRIEF DESCRIPTION OF THE DRAWINGS

The disclosure will become more fully understood from the detailed description given herein below for illustration only, and thus not limitative of the disclosure, wherein:

FIG. 1 illustrates a partial perspective view of an inductive keyboard device according to an exemplary first embodiment of the instant disclosure;

FIG. 2 illustrates a partial exploded view of an inductive keyboard device according to a first embodiment of the instant disclosure;

FIG. 3 illustrates a cross-sectional view of the inductive keyboard device of the first embodiment of the instant disclosure;

FIG. 4 illustrates a schematic view of the inductive keyboard device of the first embodiment of the instant disclosure, where the keycap of the inductive keyboard device is pressed;

FIG. 5 illustrates a graph showing the relationship between the change of the inductance values of the annular inductor and the movement of the keycap of the inductive keyboard device according to some embodiments of the instant disclosure;

FIG. 6 illustrates a cross-sectional view of an inductive keyboard device according to a second embodiment of the instant disclosure;

FIG. 7 illustrates an exploded view of an inductive keyboard device according to a third embodiment of the instant disclosure;

FIG. 8 illustrates a cross-sectional view of the inductive keyboard device of the third embodiment of the instant disclosure;

FIG. 9 illustrates a schematic view of the inductive keyboard device of the third embodiment of the instant disclosure, where the keycap of the inductive keyboard device is pressed;

FIG. 10 illustrates an exploded view of an inductive keyboard device according to a fourth embodiment of the instant disclosure;

FIG. 11 illustrates a cross-sectional view of the inductive keyboard device of the fourth embodiment of the instant disclosure;

FIG. 12 illustrates a schematic view of the inductive keyboard device of the fourth embodiment of the instant disclosure, where the keycap of the inductive keyboard device is pressed;

FIG. 13 illustrates an exploded view of an inductive keyboard device according to a fifth embodiment of the instant disclosure;

FIG. 14 illustrates a cross-sectional view of the inductive keyboard device of the fifth embodiment of the instant disclosure; and

FIG. 15 illustrates a schematic view of the inductive keyboard device of the fifth embodiment of the instant disclosure, where the keycap of the inductive keyboard device is pressed.

### DETAILED DESCRIPTION

Embodiments are provided for facilitating the descriptions of the instant disclosure. However, the embodiments are provided as examples for illustrative purpose, but not a limitation to the instant disclosure. Moreover, in the figures, some components are omitted to show the technical features of the instant disclosure clearly. Furthermore, in all the figures, the same reference numbers refer to identical or similar elements.

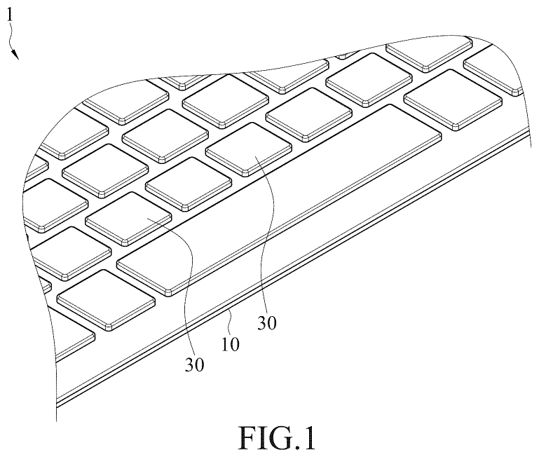

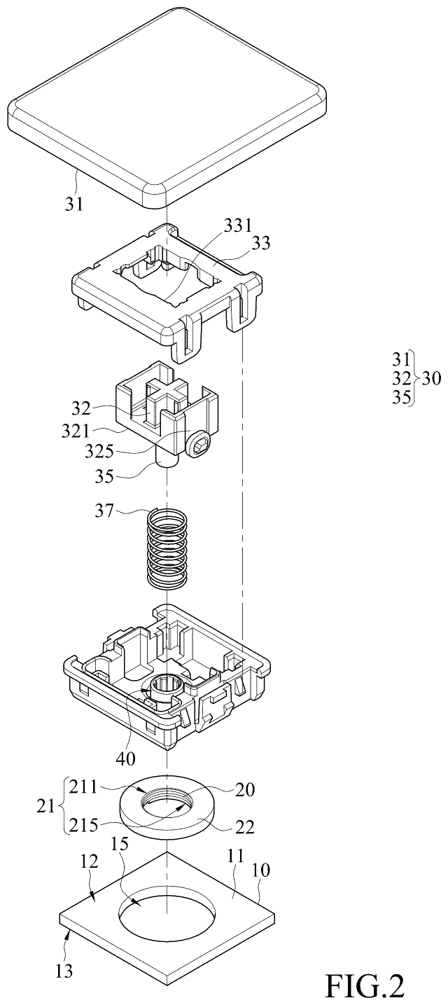

FIG. 1 illustrates a partial perspective view of an inductive keyboard device according to an exemplary first embodiment of the instant disclosure. FIG. 2 illustrates a partial exploded view of an inductive keyboard device according to a first embodiment of the instant disclosure. As shown in FIG. 1 and FIG. 2, in this embodiment, the inductive keyboard device 1 comprises a circuit board 10, an annular inductor 20, and at least one key 30. In this embodiment, the number of the key 30 is plural and the keys 30 are arranged on the circuit board 10. In some embodiments, the inductive keyboard device 1 may be utilized for various electronic devices (e.g., as the input devices of laptop computers, notebook computers, or other electronic devices), and users can operate the inductive keyboard device 1 to generate corresponding signal(s).

As shown in FIG. 1 to FIG. 3, the circuit board 10 has a top surface 12 and a bottom surface 13 opposite to the top surface 12, and the top surface 12 has at least one assembling region 11 (for example, the rectangular region shown in FIG. 2). In other words, in this embodiment, the assembling region 11 is a region of the top surface 12 of the circuit board 10, and the number of the assembling region 11 is plural, so that the keys 30 can be correspondingly assembled on the assembling regions 11.

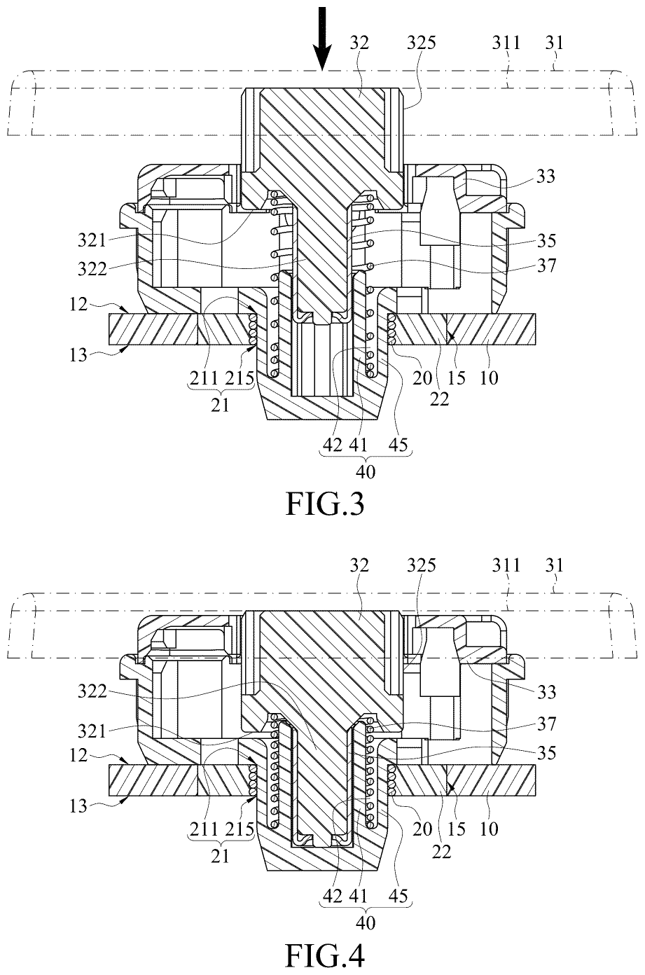

FIG. 3 illustrates a cross-sectional view of the inductive keyboard device of the first embodiment of the instant disclosure. FIG. 4 illustrates a schematic view of the inductive keyboard device of the first embodiment of the instant disclosure, where the keycap of the inductive keyboard device is pressed. As shown in FIG. 2 to FIG. 4, take one of the assembling regions 11 as an example, the assembling region 11 has a hole 15. In this embodiment, the hole 15 is a through hole defined through the circuit board 10 from the top surface 12 to the bottom surface 13. In other embodiments, the hole 15 may be a slot recessed from the top surface 12 of the circuit board 10, but the instant disclosure is not limited thereto.

As shown in FIG. 2 to FIG. 4, the annular inductor 20 is in the hole 15 of the circuit board 10, and the annular inductor 20 is arranged to form an axial sensing channel 21. In this embodiment, the annular inductor 20 is a spiral coil; for example, the spiral coil may be formed by winding a conductive wire (e.g., a copper wire or an aluminum wire) to have a three-dimensional spiral structure, and the axial sensing channel 21 is the internal channel enclosed by the spiral coil. Moreover, the annular inductor 20 may be electrically connected to a power supply or a circuit on the circuit board 10, so that electricity can be supplied to the annular inductor 20 through the power supply or the circuit board 10.

In some embodiments, the shapes of the annular inductor 20 and the hole 15 may correspond to each other. For example, the shapes of the annular inductor 20 and the hole 15 may be circular (as shown in FIG. 2), elliptical, square, or other regular shapes, but the instant disclosure is not limited thereto. In some other embodiments, the shapes of the annular inductor 20 and the hole 15 may be different from each other.

As shown in FIG. 2 to FIG. 4, each of the keys 30 comprises a keycap 31 and a magnetic component 35, the keycap 31 is above the assembling region 11 and at a height position, the magnetic component 35 is connected to the keycap 31, and a position of the magnetic component 35 corresponds to a position of the axial sensing channel 21 of the annular inductor 20. The magnetic component 35 may be made of iron, cobalt, nickel, silicon steel, or other magnetic-conductive materials (which may be composite materials), and the magnetic component 35 may be linked to the keycap 31; for example, the magnetic component 35 may be directly connected to the keycap 31 or indirectly connected to the keycap 31 through other components.

As shown in FIG. 2 to FIG. 4, each of the keys 30 comprises a key column 32 and a frame 33, the keycap 31 has an inner surface 311 facing the circuit board 31, the key column 32 is connected to the inner surface 311, and the key column 32 has a bottom portion 321 and a peripheral surface 325. The frame 33 is on the circuit board 10 and has a guide groove 331. The key column 32 of the key 30 is slidably assembled in the guide groove 331 of the frame 33, so that the key column 32 can slide with respect to the guide groove 331 along a vertical direction. In this embodiment, a middle portion of the bottom portion 321 of the key column 32 has a protruding column 322. In this embodiment, the magnetic component 35 is a hollow sleeve member fitted over the protruding column 322, so that the magnetic component 35 is indirectly connected to the keycap 31 through the key column 32, and the axial sensing channel 21 of the annular inductor 20 is at a middle portion of the assembling region 11 to correspond to the position of the magnetic component 35.

As shown in FIG. 3 and FIG. 4, a resilient member is between the keycap 31 and the circuit board 10; for example, the resilient member may be a rubber dome, a metal dome, a metal elastic piece, a spring, a magnetic member, or the like. In this embodiment, the resilient member is a spring 37, and one end of the spring 37 abuts against the key column 32 and the keycap 31, so that the keycap 31 is at the height position (as the position shown in FIG. 3). When the keycap 31 is pressed by a user, the keycap 31 is moved downwards and toward the circuit board 10 to press the spring 37, so that the spring 37 is pressed to store an elastic force. When the keycap 31 is released, the elastic force stored in the spring 37 can drive the keycap 31 to be moved upwards and back to the height position resiliently.

As shown in FIG. 3 and FIG. 4, during the process that the keycap 31 is pressed by the user (as indicated by the arrow shown in FIG. 3) to be moved from the height position toward the circuit board 10, the keycap 31 can drive the magnetic component 35 to be moved axially in the axial sensing channel 21 of the annular inductor 20 (as shown in FIG. 4). For example, in this embodiment, the axial sensing channel 21 has a top end 211 and a bottom end 215, and the top end 211 is nearer to the keycap 31 as compared with the bottom end 215 (in other words, in this embodiment, a distance between the top end 211 and the keycap 31 is less than a distance between the bottom end 215 and the keycap 31). Specifically, in this embodiment, the top end 211 and the bottom end 215 are spaced apart from each other and not arranged on the same plane. When the keycap 31 is at the height position, the magnetic component 35 is above the circuit board 10, and a portion of the magnetic component 35 (in this embodiment, the bottom portion of the magnetic component 35) is at the interior of the axial sensing channel 21. In other words, in this embodiment, the annular inductor 20 is between the circuit board 10 and the portion of the magnetic component 35. During the movement of the keycap 31 toward the circuit board 10, the magnetic component 35 enters the interior of the axial sensing channel 21 from the top end 211, so that the magnetic component 35 has an induction with the annular inductor 20 to generate inductance values continuously.

As above, in the inductive keyboard device 1 according to one or some embodiments of the instant disclosure, during the process that the keycap 31 is pressed to be moved toward the circuit board 10, the keycap 31 can drive the magnetic component 35 to be moved axially in the axial sensing channel 21 of the annular inductor 20. Therefore, during the movement of the keycap 31, the annular inductor 20 can generate different inductance values continuously, and the position of the keycap 31 and the pressing extent of the keycap 31 can be determined according to the change of the inductance values. Hence, according to one or some embodiments of the instant disclosure, the inductive keyboard device 1 can provide the user with various operation modes to meet different user requirements and application scenarios. For example, supposed that the overall movable stroke is 4 mm, in the case that the keycap 31 is moved by 0.5 mm, 1 mm, 1.5 mm, and 2 mm, the keycap 31 has an induction with the annular inductor 20 to generate different inductance values. Therefore, according to the change of the inductance values, the position of the keycap 31 and the touch pressure of the keycap 31 can be determined, so that the inductive keyboard device 1 can perform different operations and controls. For example, when the inductive keyboard device 1 is utilized for control the movement of a game character, the more the movement of the keycap 31 is, the faster the movement of the game character is.

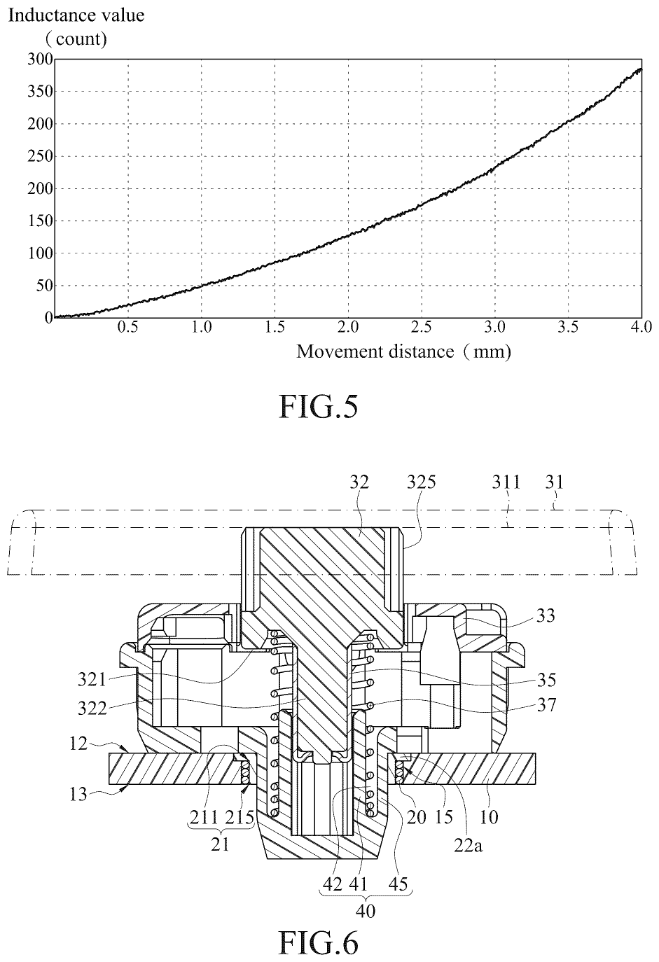

Moreover, with reference to FIG. 5. In the inductive keyboard device 1 according to one or some embodiments of the instant disclosure, the annular inductor 20 is in the hole 15 of the circuit board 10; because the inductance value is related to the movement of the keycap 31, the change of the inductance values can be achieved more linearly, and the inductive keyboard device 1 according to one or some embodiments of the instant disclosure can provide the user with more detail and accurate control operations. For example, because the change of the inductance values becomes more linear (as shown in FIG. 5), even though the keycap 31 has a very short movement (e.g., 0.2 mm), an inductance value which is apparently different from the original inductance value can be generated, and the inductive keyboard device 1 can provide the user with multi-stage operations and controls. More specifically, according to some embodiments, the annular inductor 20 is not disposed on the surface of the circuit board 10. Therefore, according to some embodiments, both of the condition that the inductance value changes dramatically only when the magnetic component 35 comes close to the annular inductor 20 and the condition that the inductance value almost does not change when the magnetic component 35 moves away from the annular inductor 20 do not occur. Hence, the fineness and the accuracy of the operations and controls can be adjusted.

As shown in FIG. 3 and FIG. 4, in this embodiment, the inductive keyboard device 1 comprises a base 40. The base 40 is in the axial sensing channel 21 of the annular inductor 20 and in the hole 15 of the circuit board 10. In other words, in this embodiment, the hole 15 is not only for being assembled with the annular inductor 20 but also for being assembled with the base 40. The base 40 comprises an axial cylinder 41. In this embodiment, one of two ends of the axial cylinder 41 protrudes from the top end 211 of the axial sensing channel 21, and the other end of the axial cylinder 41 protrudes from the bottom end 215 of the axial sensing channel 21. When the keycap 31 is at the height position (as shown in FIG. 3), a portion of the magnetic component 35 (in this embodiment, the bottom portion of the magnetic component 35) is at an interior of the axial cylinder 41. During the movement of the keycap 31 toward the circuit board 10 (as shown in FIG. 4), the keycap 31 can drive the magnetic component 35 to be moved axially in the axial cylinder 41. Therefore, through the guiding of the axial cylinder 41, the operations of the magnetic component 35, the keycap 31, and the key column 32 can be performed more stably.

Furthermore, as shown in FIG. 3 and FIG. 4, in this embodiment, the base 40 further comprises an outer tubular wall 45, the outer tubular wall 45 surrounds an outer periphery of the axial cylinder 41, both the outer tubular wall 45 and the axial cylinder 41 are in the hole 15 of the circuit board 10, and an annular groove 42 is between the outer tubular wall 45 and the axial cylinder 41. One end of the spring 37 abuts against the key column 32 and the keycap 31, and the other end of the spring 37 is in the annular groove 42, so that a portion of the spring 37 is in the axial sensing channel 21 of the annular inductor 20. The spring 37 may be a magnetic spring; for example, the spring 37 may be made of iron, cobalt, nickel, silicon steel, or other magnetic-conductive materials (which may be composite materials). Therefore, during the process that the keycap 31 is pressed by the user to be moved toward the circuit board 10, the keycap 31 not only drives the magnetic component 35 to be moved axially in the axial sensing channel 21 but also compresses the spring 37 to change the volume of the spring 37 in the axial sensing channel 21. Hence, both the magnetic component 35 and the spring 37 have an induction with the annular inductor 20 to increase the inductance value. Accordingly, the accuracy for determining the position of the keycap 31 can be increased.

As shown in FIG. 2 to FIG. 4, in some embodiments, the annular inductor 20 may surround an inner periphery of an annular member 22, and the annular inductor 20 is assembled in the hole 15 of the circuit board 10 through the annular member 22. Alternatively, as shown in FIG. 6, in another embodiment, the annular inductor 20 may surround an outer periphery of an annular member 22a, but the instant disclosure is not limited thereto. The annular member 22 or the annular member 22a may be made of a metal material to increase the inductive effect.

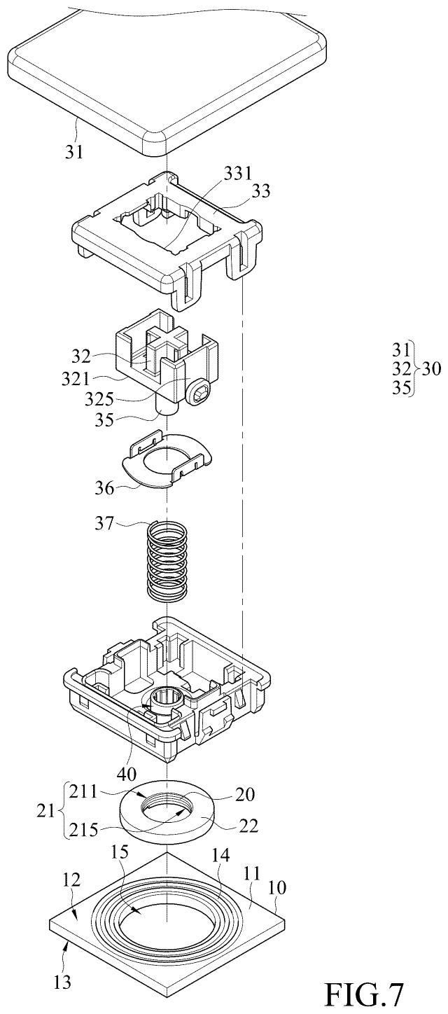

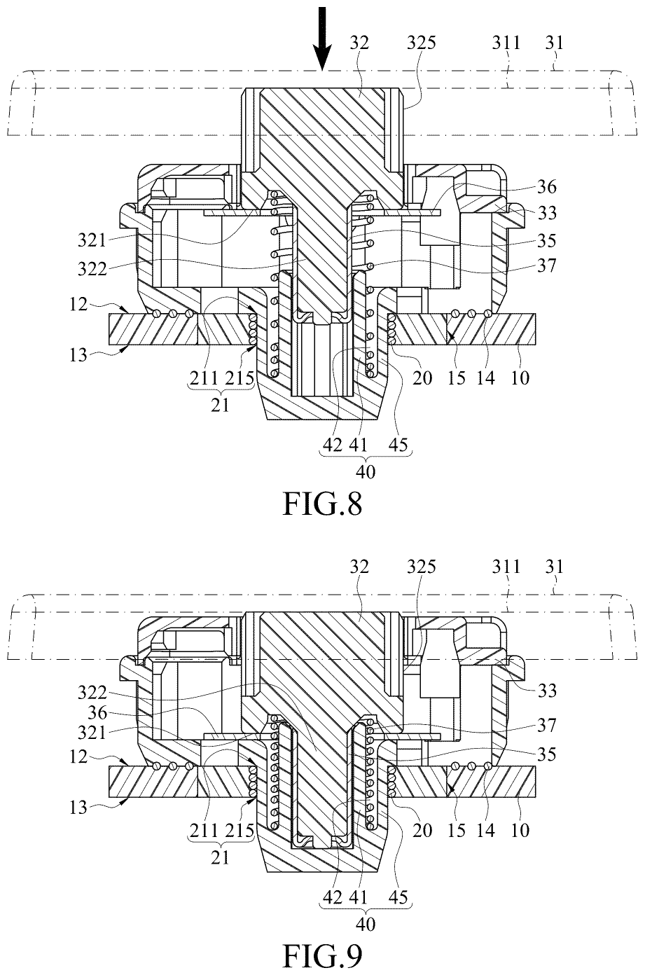

FIG. 7 illustrates an exploded view of an inductive keyboard device according to a third embodiment of the instant disclosure. FIG. 8 illustrates a cross-sectional view of the inductive keyboard device of the third embodiment of the instant disclosure. FIG. 9 illustrates a schematic view of the inductive keyboard device of the third embodiment of the instant disclosure, where the keycap of the inductive keyboard device is pressed. As shown in FIG. 7 to FIG. 9, the difference between this embodiment and the first embodiment at least lies in that, in this embodiment, a magnetic plate 36 is further between the circuit board 10 and the keycap 31; the magnetic plate 36 may be made of iron, cobalt, nickel, silicon steel, or other magnetic-conductive materials (which may be composite materials). The magnetic plate 36 is connected to the bottom portion 321 of the key column 32 and thus is indirectly connected to the keycap 31. In this embodiment, the magnetic plate 36 is an annular plate surrounding the periphery of the magnetic component 35, but the instant disclosure is not limited thereto. Moreover, as shown in FIG. 8 and FIG. 9, during the process that the keycap 31 is pressed by the user (as indicated by the arrow shown in FIG. 8) to be moved toward the circuit board 10, the keycap 31 not only drives the magnetic component 35 to be moved axially in the axial sensing channel 21 and compresses the spring 37 to change the volume of the spring 37 in the axial sensing channel 21, the keycap 31 but also drives the magnetic plate 36 to come close to the annular inductor 20. Hence, all the magnetic component 35, the spring 37, and the magnetic plate 36 have an induction with the annular inductor 20 to increase the inductance value. Accordingly, the accuracy for determining the position of the keycap 31 can be increased.

As shown in FIG. 7 to FIG. 9, in this embodiment, an inductive coil 14 is provided on the top surface 12 of the circuit board 10, and the inductive coil 14 is between the top surface 12 and the magnetic plate 36. Therefore, during the process that the keycap 31 is pressed to be moved toward the circuit board 10, the keycap 31 can drive the magnetic plate 36 to come close to the inductive coil 14 to generate the inductive effect so as to increase the inductance value. Accordingly, the accuracy for determining the position of the keycap 31 can be increased.

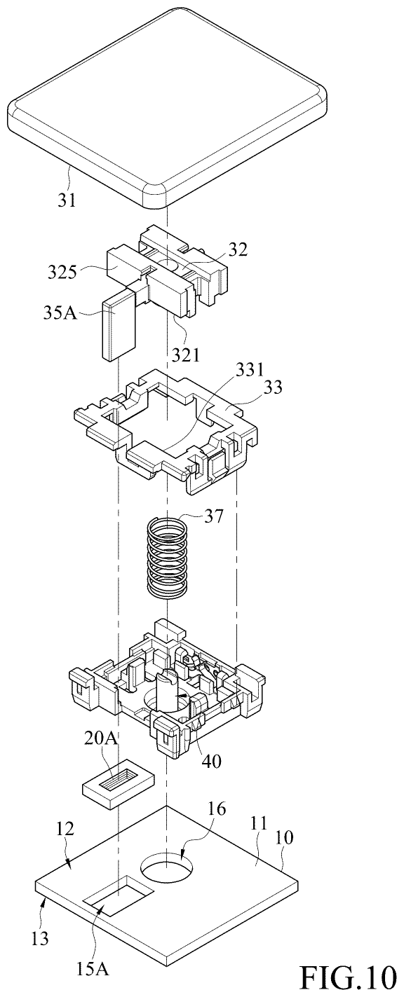

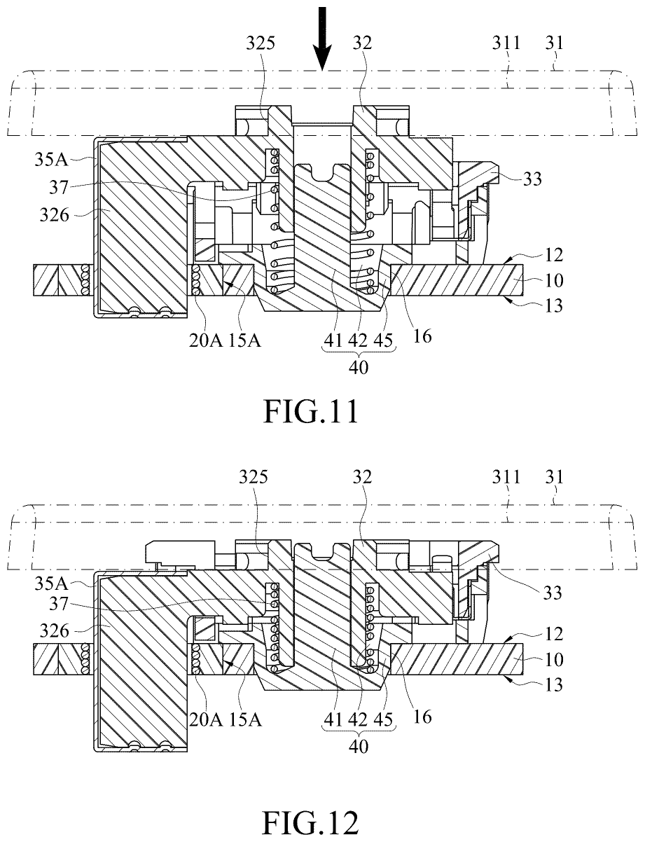

FIG. 10 illustrates an exploded view of an inductive keyboard device according to a fourth embodiment of the instant disclosure. FIG. 11 illustrates a cross-sectional view of the inductive keyboard device of the fourth embodiment of the instant disclosure. FIG. 12 illustrates a schematic view of the inductive keyboard device of the fourth embodiment of the instant disclosure, where the keycap of the inductive keyboard device is pressed. As shown in FIG. 10 to FIG. 12, the difference between this embodiment and the first embodiment at least lies in that, in this embodiment, the magnetic component 35A is connected to the peripheral surface 325 of the key column 32, rather than the bottom portion 321 of the key column 32. In this embodiment, an extension plate 326 integrally extends from the peripheral surface 325 of the key column 32, and the magnetic component 35A is a rectangular sleeve member and fitted over the extension plate 326, but the instant disclosure is not limited thereto. In some other embodiments, the magnetic component 35A may be directly connected to the peripheral surface 325 of the key column 32. The annular inductor 20A and the hole 15A on the circuit board 10 are both adjacent to one side of the assembling region 11, so that the positions of the annular inductor 20A and the hole 15A correspond to the position of the magnetic component 35A. In some embodiments, the shape of the hole 15A may be circular, elliptical, square (as shown in FIG. 10), or the like, but the instant disclosure is not limited thereto. In some embodiments, the shape surrounded by the annular inductor 20A may correspond to the shape of the hole 15A.

Moreover, as shown in FIG. 10 to FIG. 12, in this embodiment, the circuit board 10 further has an assembling hole 16 for being assembled with the base 40. In other words, in this embodiment, the assembling hole 16 and the hole 15A are at different positions of the circuit board 10, rather than being arranged coaxially.

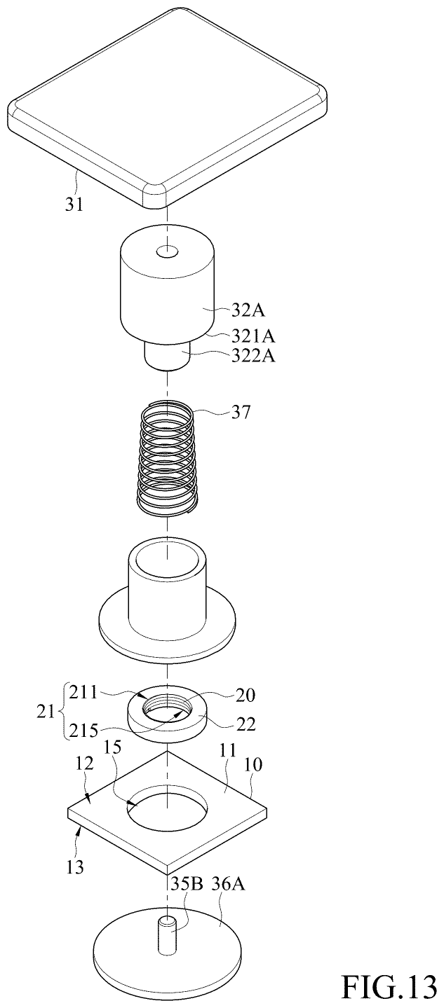

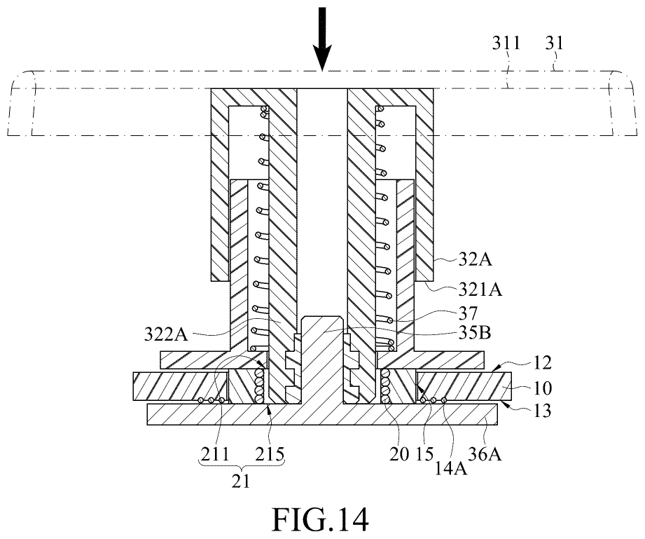

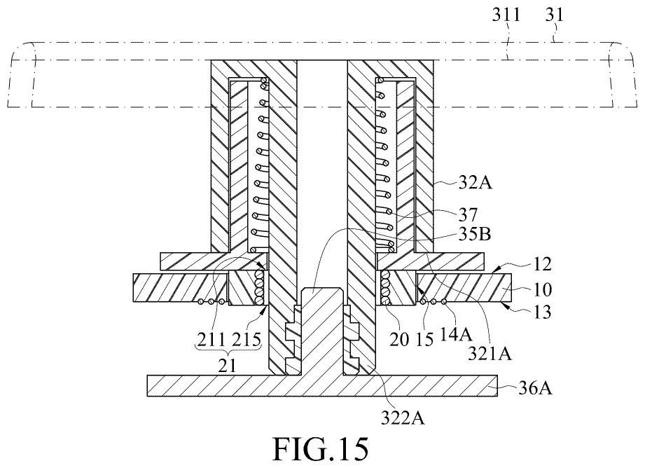

FIG. 13 illustrates an exploded view of an inductive keyboard device according to a fifth embodiment of the instant disclosure. FIG. 14 illustrates a cross-sectional view of the inductive keyboard device of the fifth embodiment of the instant disclosure. FIG. 15 illustrates a schematic view of the inductive keyboard device of the fifth embodiment of the instant disclosure, where the keycap of the inductive keyboard device is pressed. As shown in FIG. 13 to FIG. 15, the difference between this embodiment and the first embodiment at least lies in that, in this embodiment, the protruding column 322A extending from the bottom portion 321A of the key column 32A of the keycap 31 is hollowed, and the protruding column 322A extends into the interior of the axial sensing channel 21 of the annular inductor 20 in the circuit board 10, and the magnetic component 35B is a solid cylinder assembled in the protruding column 322A. When the keycap 31 is at the height position (as shown in FIG. 14), the magnetic component 35B is at the interior of the axial sensing channel 21. During the process that the keycap 31 is pressed by the user to be moved from the height position toward the circuit board 10 (as shown in FIG. 15), the keycap 31 can drive the magnetic component 35B to leave the interior of the axial sensing channel 21 from the bottom end 215 while still allow the magnetic component 35B to have an induction with the annular inductor 20 to generate the inductance value. Moreover, as shown in FIG. 15, after the keycap 31 is pressed, a portion of the magnetic component 35B (in this embodiment, the top portion of the magnetic component 35B) may be at the interior of the axial sensing channel 21, but the instant disclosure is not limited thereto. In some other embodiments, after the keycap 31 is pressed, the entirety of the magnetic component 35B may be outside the axial sensing channel 21.

As shown in FIG. 14 and FIG. 15, the top surface 12 of the circuit board 10 is nearer to the keycap 31 as compared with the bottom surface 13 (in other words, in this embodiment, the distance between the top surface 12 of the circuit board 10 and the keycap 31 is less than the distance between the bottom surface 13 of the circuit board 10 and the keycap 31), and the magnetic component 35B is further connected to a magnetic plate 36A; the magnetic plate 36A may be made of iron, cobalt, nickel, silicon steel, or other magnetic-conductive materials (which may be composite materials). In this embodiment, the magnetic component 35B is integrally connected to a center portion of the magnetic plate 36A. Moreover, when the keycap 31 is at the height position (as shown in FIG. 14), the magnetic plate 36A is stacked on the bottom surface 13 of the circuit board 10 and adjacent to the annular inductor 20. During the process that the keycap 31 is pressed by the user to be moved from the height position toward the circuit board 10 (as shown in FIG. 15), the keycap 31 can drive the magnetic plate 36A to be moved away from the circuit board 10, so that the magnetic plate 36A has an induction with the annular inductor 20 to generate the inductance value.

Furthermore, as shown in FIG. 14 and FIG. 15, in this embodiment, an inductive coil 14A is further provided on the circuit board 10, and the inductive coil 14A is between the bottom surface 13 and the magnetic plate 36A. Therefore, during the process that the keycap 31 is pressed by the user to be moved toward the circuit board 10, the magnetic plate 36A also has an induction with the inductive coil 14A to generate the inductance value. Accordingly, the accuracy for determining the position of the keycap 31 can be increased.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. An inductive keyboard device comprising:
a circuit board having an assembling region, wherein the assembling region has a hole;
an annular inductor in the hole, wherein the annular inductor is arranged to form an axial sensing channel; and
a key comprising a keycap and a magnetic component, wherein the keycap is above the assembling region and at a height position, the magnetic component is connected to the keycap, and a position of the magnetic component corresponds to a position of the axial sensing channel;
wherein the keycap selectively has a movement from the height position toward the circuit board, and during the movement of the keycap, the keycap drives the magnetic component to be moved axially in the axial sensing channel of the annular inductor.

2. The inductive keyboard device according to claim 1, wherein when the keycap is at the height position, a portion of the magnetic component is at an interior of the axial sensing channel.

3. The inductive keyboard device according to claim 1, wherein the key comprises a key column, the keycap has an inner surface facing the circuit board, the key column is connected to the inner surface, the key column has a bottom portion and a peripheral surface, and the magnetic component is connected to the bottom portion or the peripheral surface.

4. The inductive keyboard device according to claim 3, wherein a center portion of the bottom portion of the key column has a protruding column, and the magnetic component is fitted over the protruding column.

5. The inductive keyboard device according to claim 1, wherein the axial sensing channel has a top end and a bottom end, and the top end is nearer to the keycap as compared with the bottom end; during the movement of the keycap, the magnetic component enters an interior of the axial sensing channel from the top end.

6. The inductive keyboard device according to claim 1, further comprising a base, wherein the base is in the axial sensing channel, and the base comprises an axial cylinder; during the movement of the keycap, the magnetic component is moved along the axial cylinder axially.

7. The inductive keyboard device according to claim 6, wherein the base comprises an outer tubular wall, the outer tubular wall surrounds an outer periphery of the axial cylinder, an annular groove is between the outer tubular wall and the axial cylinder, a magnetic spring is between the circuit board and the keycap, one of two ends of the magnetic spring abuts against the keycap, and the other end of the magnetic spring is in the annular groove.

8. The inductive keyboard device according to claim 1, further comprising a magnetic plate, wherein the magnetic plate is connected to the keycap and at a periphery of the magnetic component; during the movement of the keycap, the keycap drives the magnetic plate to be moved toward the annular inductor.

9. The inductive keyboard device according to claim 8, wherein the circuit board has a top surface and a bottom surface, an inductive coil is on the top surface, and the inductive coil is between the top surface and the magnetic plate; during the movement of the keycap, the keycap drives the magnetic plate to be moved toward the inductive coil.

10. The inductive keyboard device according to claim 1, wherein the axial sensing channel has a top end and a bottom end, and the top end is nearer to the keycap as compared with the bottom end; when the keycap is at the height position, the magnetic component is at an interior of the axial sensing channel; during the movement of the keycap, the magnetic component leaves the interior of the axial sensing channel from the bottom end.

11. The inductive keyboard device according to claim 10, wherein the circuit board has a top surface and a bottom surface, and the magnetic component is further connected to a magnetic plate; when the keycap is at the height position, the magnetic plate is stacked on the bottom surface of the circuit board and adjacent to the annular inductor; during the movement of the keycap, the magnetic plate is moved away from the circuit board.

12. The inductive keyboard device according to claim 11, wherein the circuit board comprises an inductive coil, and the inductive coil is between the bottom surface and the magnetic plate.
